(19) United States
(12) Patent Application Publication
(10) Pub. No.: US 2007/0172175 A1
(43) Pub. Date: Jul. 26, 2007

(54) Hermetic fiber optic ferrule

(76) Inventors: Talapker Imanbayev, Lake Oswego, OR (US); Keith Sheach, Ottawa (CA); Timothy W. Van Kurin, Lake Oswego, OR (US)

Correspondence Address: THOMAS F. LENIHAN;TEKTRONIX, INC., 14150 S. W. KARL BRAUN DRIVE, P.O. BOX 500 (50-LAW), BEAVERTON, OR, 97077-0001, US

(21) Appl. No.: 11/341,336

(22) Filed: Jan. 26, 2006

(51) Int. Cl. G02B 6/36

(52) U.S. Cl. 385/78; 385/76; 385/77; 385/83; 385/86

(57) ABSTRACT

A fiber optic ferrule assembly has an elongated ferrule body on a major axis and having a rear end opposite its free end. The body has a passage extending from a rear aperture at the rear end to a foreword aperture at the front end. A cable extending from the rear end of the ferrule has several optical fibers extending to the forward end. The ferrule has several alignment features, each closely receiving a fiber. A hermetic sealant applied to the alignment features to provide a hermetic seal. The sealant may be applied via a lateral access aperture, which may be sealed by the sealant. The ends of the passage may be sealed by different materials, and the cable may have a jacket that is partially received in the ferrule.

### FIELD OF THE INVENTION

The subject invention generally relates to the field of fiber optics, and environmental seals for connecting fiber ends to electronic devices.

### BACKGROUND OF THE INVENTION

Optical fibers are used in a wide variety of applications ranging from telecommunications to medical technology and optical components. For certain applications, it is desirable to hermetically seal optical devices in a housing to prevent deterioration in performance due to moisture and other species present in the atmosphere. A fiber entering such a device should not violate the hermeticity of the device, even though an aperture is required to admit the fiber. Therefore, the fiber may be terminated with a ferrule that is hermetic with respect to the fiber, and can be made hermetic with respect to the device housing aperture. Furthermore, it is desirable to improve the reliability of optical fibers in hermetically sealed fiber ferrules and feedthroughs.

A number of fiber optic applications require optical fibers to be packaged in a ferrule, such as a metal, glass, or ceramic ferrule, so that the fiber tip can be aligned and fixed with respect to an optical component. For a variety of applications it is desirable that such a ferrule is a hermetic ferrule. Further, in certain applications it is necessary to bring an optical fiber into a sealed package which requires a hermetic fiber feedthrough. Herein arises the need for a satisfactory method to hermetically seal optical fibers within fittings or sleeves.

Device packages that incorporate an optical or opto-electronic component have an aperture for the feedthrough of the optical fibers that conduct light to or from the package. It has been usual practice to support the connecting portion of the fibers in a metal sleeve and then for the sleeve to be mounted in the aperture, the fibers being held and sealed in the sleeve by a metal solder or epoxy resin. However, these approaches have important disadvantages.

If a fiber is to be soldered into the sleeve it is common practice to metallize the fiber so that the metal solder will adhere to the fiber. However, the additional handling of the delicate fiber during the metallization process can cause damage, and traditional fiber metallization processes are expensive.

An epoxy process, on the other hand, does not provide hermeticity, as moisture and gases can diffuse through the epoxy adhesive. In addition, there is a slow release of gases from the resin (even after heat treatment) and the gases that are discharged can be harmful to components within the package.

U.S. Pat. No. 5,177,806 issued on Jan. 5, 1993 to Abbott et al. discloses an optical fiber feedthrough using a glass seal for sealing the optical fiber within the metal sleeve. The hermetic seal between the optical fiber and the feedthrough sleeve is accomplished utilizing glass solder. The stripped fiber is fed through a capillary in the glass solder pre-form. During a subsequent heat treatment the pre-form is heated to its flow temperature so that it forms a seal between the fiber and the sleeve.

Methods are known for placing and affixing optical fibers in ferrules and sleeves of different types for the purpose of providing a protective sheath for reducing damage to optical fibers that would otherwise be exposed, and for attempting to provide a housing for optical fibers. Furthermore, a centering of stripped fibers within a capillary, as commonly done in the prior art, is a delicate task involving great risk of causing damage to the fiber. The small clearance between the sleeve and the fiber make it very difficult to insert the fiber without damage, such as scratches or nicks in the fiber, which will result in a weak joint and can eventually lead to fiber breakage.

Furthermore, fiber-optic devices such as arrayed waveguide products employ fiber ribbons, typically consisting of, but not limited to 4 to 16 fibers, arranged in an array. These devices are generally susceptible to moisture, and therefore it is desired to package these devices in a hermetic box. However, currently this is prohibited by the unavailability of suitable hermetic ribbon feedthroughs.

The unavailability of suitable hermetic ribbon feedthroughs is partly due to the fact that, compared to a single fiber, it is a challenging task to hermetically seal fiber ribbons, since a reliable seal has to be made at the interface between a number of fibers and a joining medium, in addition to the seal between the joining material and the enclosure. This task is further complicated by the fact that the center to center spacing between the fibers tends to be relatively small (typically 250 microns) and because fibers should be kept in within +/−2 micron accuracy. A robust design and process is required to guarantee a reliable seal at the multiple leak paths. Further, with multiple fibers on close spacing, alignment of the fibers to a precise spacing is needed to avoid misalignment. Misalignment can result in light losses or undesired cross-talk between the fiber ends and the emitters or detectors with which they communicate. Light losses limit the length of the fiber over which signals travel, or require increased power output to generate adequate light as compensation. Cross-talk occurs when light from a misaligned fiber strikes a detector adjacent to the intended detector, thus coupling incorrectly.

It is an aspect of the present invention to provide hermetic waveguide seals with improved reliability.

It is a further aspect to provide a method of making such hermetic waveguide seals.

It is an aspect of the present invention to provide a method for making a hermetic waveguide ferrule and/or feedthrough using a novel glass solder process.

It is a further aspect of the present invention to provide a reliable hermetic waveguide ferrule and/or feedthrough utilizing a glass solder process.

It is an aspect of the present invention to provide unique registration features within the hermetic ferrule that assure precise (passive) registration of optical fibers with respect to a common centerline, providing planar alignment and center to center spacing precision.

It is another aspect of the invention to provide a hermetic ribbon feedthrough and a method of making the same.

Accordingly, there is a need for a method and apparatus for providing hermetic connection of a fiber ribbon to an instrument. The preferred embodiment provides this in the following:

### SUMMARY OF THE INVENTION

A fiber optic ferrule assembly has an elongated ferrule body on a major axis and having a rear end opposite its free end. The body has a passage extending from a rear aperture at the rear end to a foreword aperture at the front end. A cable extending from the rear end of the ferrule has several optical fibers extending to the forward end. The ferrule has several alignment features, each closely receiving a fiber. A hermetic sealant is applied to the interface between the fibers and key ferrule features to provide a hermetic seal. The sealant may be applied via a lateral access aperture, which may be sealed by the sealant. The ends of the passage may be encapsulated by different materials, and the cable may have a jacket that is partially received in the ferrule.

### BRIEF DESCRIPTION OF THE DRAWINGS

FIG. 1 is a perspective view of a ferrule assembly according to a preferred embodiment of the invention, in conjunction with a instrument to which it connects.

FIG. 2 is an enlarged perspective view of a ferrule component of the preferred embodiment.

FIG. 3 is a plan sectional view taken along line 3-3 of FIG. 1.

FIG. 4 is a plan sectional view taken along line 4-4 of FIG. 3.

### DETAILED DESCRIPTION OF A PREFERRED EMBODIMENT

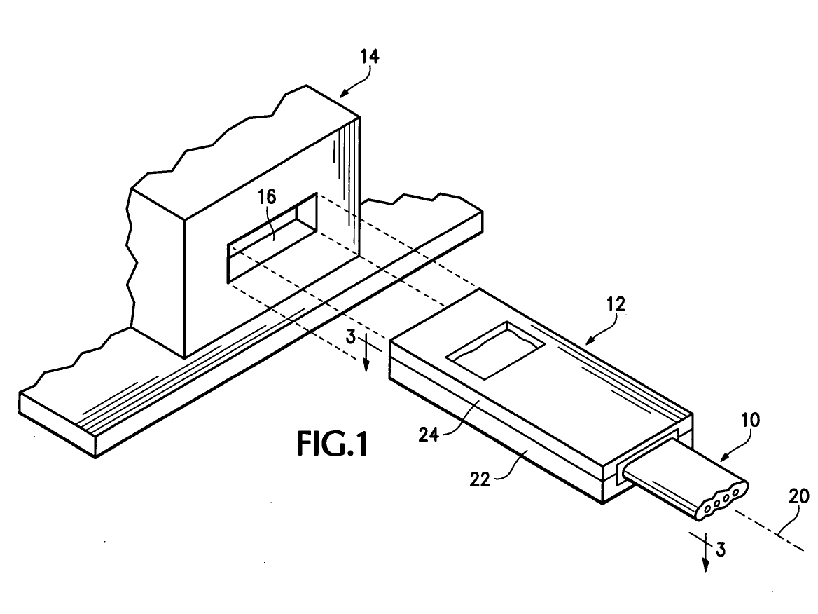

FIG. 1 shows a fiber optic ribbon cable 10 terminated with a ferrule 12 for connection to an optoelectronic instrument contained in a hermetic housing 14 having an aperture 16 for closely receiving the ferrule. The instrument may be of any type that employs an optical emitter or detector for sending or receiving signals to other instruments. In the preferred embodiment, the ferrule is a rectangular flat body having a rectangular cross section across its major axis 20, and the housing aperture 16 has the same rectangular shape as the cross section to closely receive the ferrule. The ferrule and housing aperture are nominally rectangular but may have slightly rounded or chamfered features at corners and edges. The ferrule has a main body 22, and a flat lid 24 that forms the upper surface of the ferrule. The ferrule and housing are formed of materials that can maintain a hermetic seal, and which are suitable for connection to each other by conventional methods of forming a hermetic seal. The materials may be glass, ceramic, metal, and others, and may be connected by solder materials such as glass or metal, welding (if metal) or sintering methods (ceramic). The ferrule may be formed in one part instead of having a separately formed lid, but this limits the number of manufacturing process alternatives.

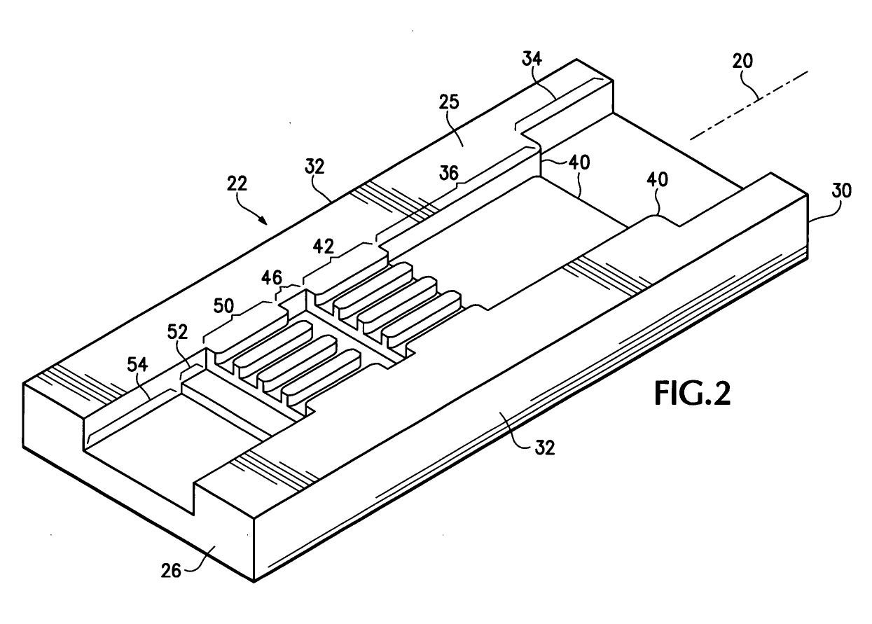

FIG. 2 shows the ferrule's main body element 22, which is a rectangular body with a pattern cut, etched, cast or pressed to varying depths from its upper surface 25. The body has a free end face 26, a rear end face 30, and opposed side faces 32. The pattern is symmetric about a vertical plane aligned with the axis 20. The defined pattern extends from end to end, and includes several segments, each of different properties.

Beginning at the rear end, the pattern has a jacket relief portion 34 of constant rectangular cross section along its length. It has a width of 2 mm, which is nearly the width of the ferrule, a depth 0.5 mm, which is adequate to loosely receive the jacket of cable 10, and a length of 2.5 mm, which is adequate to secure a sufficient length of the jacket to secure the ferrule to the cable, as will be discussed below.

A contiguous second pattern section 36 is a fiber alignment of constant rectangular cross section along its length. It has a length of 1.5 mm, and a width of 1.25 mm for 4-channel ribbon, both less than the corresponding dimensions of the jacket relief portion 34. At the transition between these two sections, the edges 40 are radiused or chamfered, so that there are no sharp corners on which fibers may inadvertently be damaged.

The third pattern section is a fiber alignment feature 42, which defines four parallel channels 44, each having a width and depth of 0.126×0.120 mm, which is adequate to closely receive an optical fiber. In alternative embodiments for different numbers and sizes of fibers, the number and sizes of the channels would be adjusted. Each channel has a flared or radiused outlet at each end to avoid sharp edges that may damage fibers. The channels are spaced apart on 0.25 mm centers, which is the spacing of transducers in the instrument with which the fibers will communicate. This is also the nominal spacing of the fibers in the cable, except that such spacing tends to be imprecise. In alternative embodiments, the second section 36 may be employed to allow fibers to spread or converge when the pitch of the fibers in the cable differs from that in the transducer.

The fourth pattern section is a first solder-blocking trough 46, which has a width of 1.25 mm and a depth of 0.3 mm, both greater than the width and depth of the alignment feature 42. The trough has a length of 0.5 mm, measured along the device axis 20. The trough 46 serves to terminate capillary passages that form in the channels in the presence of fibers, for a soldering process discussed below.

The fifth pattern section is a second fiber alignment feature or solder zone 50 having the same dimensions and characteristics as the first 42, and the sixth section is another solder-blocking trough 52, so that the channels of the solder zone are terminated on each end by solder-blocking troughs.

The seventh and final pattern section is an enlarged encapsulation receptacle 54 having a width the same as the trough 52, and a stepped down floor for a greater depth of 0.3 mm.

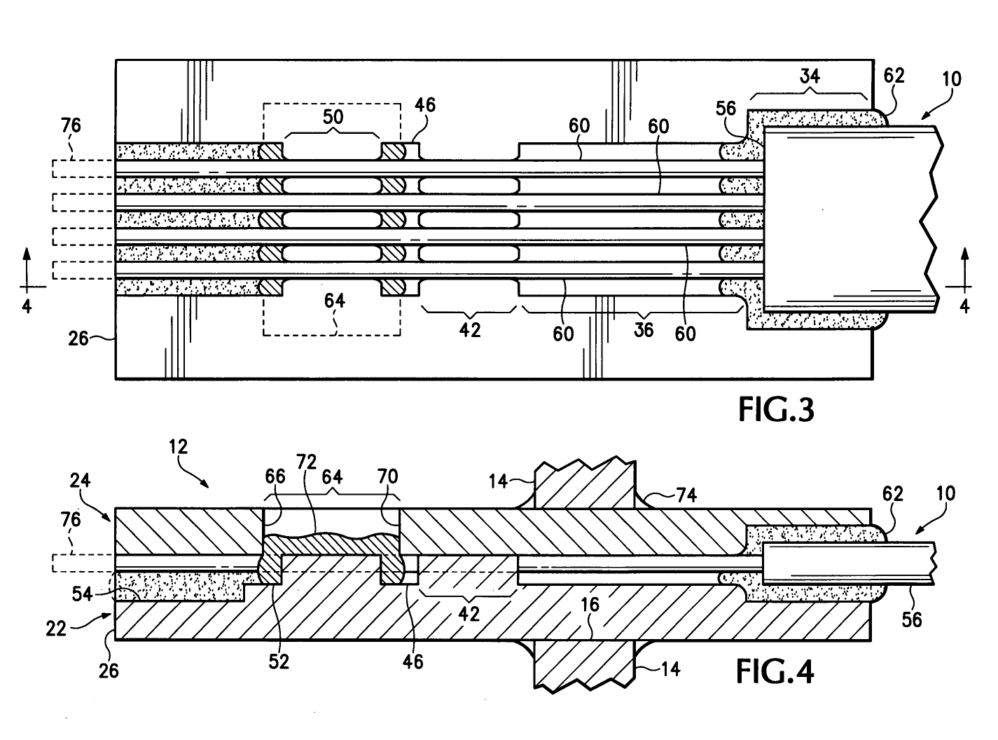

FIGS. 3 and 4 show the ferrule with cable installed. The cable jacket 56 has been stripped to expose substantial lengths of the four fibers 60, long enough to extend beyond the end 26 of the ferrule 12 when the jacket end is inserted into the jacket relief section 34. The spaces remaining in section 34 is filled with an elastomer such as silicone 62, which serves as a strain relief to absorb bending stresses between the extending cable and the ferrule, without damage or sharp bending of the cable. The thickness of the silicone prevents it from flowing a significant distance into the next section 36, where the fibers are self-supporting, and are allowed to align and even flex minimally to enter the channels of the alignment feature 42.

The fibers continue over the first trough 46, and enter the channels of the solder zone 50. The significant total distance of both alignment zones relative to the length beyond them ensures that the fibers are held parallel with minimum deviation. The stiffness of the fibers over the short distance past the end face 26 further ensures that there is minimal deviation due to flexure or the cantilevered fibers.

The lid 24 is secured and sealed to the base 22 to entirely seal the etched pattern at the side edges, including sealing each channel 44 from the others to define square-sectioned passages. The lid is a solid rectangle that overlays the rectangular base, except for a rectangular opening 64 that overlays the solder zone. The opening is wider than the solder zone to expose all the channels, and has forward 66 and rear 70 edges that are aligned with intermediate positions of the solder-blocking troughs.

A blob of glass solder 72 fills the opening 64 to seal against all edges of the opening, and has an upper surface that is recessed below the upper surface of the lid to avoid protrusions that would prevent insertion of the ferrule into an opening. The solder wicks fully into each of the channels, so that all gaps between the fibers and the channel surfaces are sealed. The solder does not wick substantially beyond the channels, because the solder-blocking troughs 46 and 52 do not provide narrow enough passages to sustain wicking. Accordingly, solder does not continue into the alignment section 42, or into the encapsulation receptacle 54. The solder provides a hermetic seal that blocks any leakage between the rear end aperture and either of the lid opening 64 and the free end aperture.

The instrument housing aperture 16 is positioned anywhere between the lid opening 64 and the rear end, and hermetically sealed by a solder seal 74.

The encapsulation chamber 54 at the free end 26 of the ferrule is filled with epoxy or other rigid sealant to provide mechanical support for the fibers. After this, the ferrule end is ground and polished to a precise flat surface so that the fibers, epoxy, and ferrule body are a flat planar surface perpendicular to the fiber axes.

In the preferred embodiment, the device is manufactured by first fabricating the ferrule body and lid. Fabrication of the body's patterns may be by etching, machining, pressing, sintering or by a deposition process. A precise process such as photolithography has the advantage that dimensional variations are not accumulated, as generally occurs with assemblies of multiple mechanical parts. The lid is attached to the body by soldering, welding, brazing or other hermetic sealant, so that all side are flush. The assembled ferrule is then ready for insertion of the cable. In an alternative embodiment, the ferrule may be produced by other means, including those that produce the piece as a single unit, in which the channels for the fibers are drilled or formed from a solid single block.

The cable is prepared by stripping the jacket to expose adequate length of fibers, which are inserted into the channels until free ends 76 extend beyond the ferrule. The ferrule end is not the finished surface, but includes extra material that will be removed during polishing. The strain relief sealant 62 is applied to mechanically secure the cable to the ferrule. After curing, the ferrule is oriented with the lid opening up, and a pre-formed solid rectangular element of glass solder that closely fills the opening is inserted into the opening, atop the solder zone. Heat is then applied to the solder, such as by a CO₂ laser (the solder being black to absorb the energy of the laser more readily than the surrounding material), or other heating methods. One reason for the length of the section 36 is to provide adequate thermal gradient between the solder zone, which can reach 325C, and the cable jacket 56 which may not exceed 100C due to the limitations of the preferred acrylate material.

1. A fiber optic ferrule assembly comprising:
an elongated ferrule body defining a major axis and having a rear end and an opposed free end;
the body defining a passage from a rear aperture at the rear end to a foreword aperture at the front end;
a cable extending from the rear end of the ferrule and having a plurality of optical fibers extending to the forward end;
the ferrule having a plurality of alignment features, each closely receiving a fiber; and
a hermetic sealant applied to the alignment features to provide a hermetic seal.

2. The assembly of claim 1 wherein the ferrule includes an aperture adjacent to and providing access to the alignment features, and wherein the sealant at least in part occupies the aperture.

3. The assembly of claim 2 wherein the ferrule has a major face parallel to the major axis, and wherein the aperture is defined in the major face.

4. The assembly of claim 1 wherein the cable includes a plurality of fibers arranged as a ribbon, and wherein the alignment features occupy a common plane.

5. The assembly of claim 1 including an elastomeric material applied in the rear aperture to provide strain relief.

6. The assembly of claim 1 including an encapsulant applied in the forward aperture to support the fibers.

7. The assembly of claim 6 wherein the ferrule body is formed of a first portion defining the alignment features, and a lid portion overlaying the first portion and enclosing the alignment features.

8. The assembly of claim 7 wherein the plane is perpendicular to the ferrule axis.

9. The assembly of claim 1 where the forward and rear apertures are filled with different materials.

10. The assembly of claim 1 wherein the alignment feature includes a zone defining plurality of parallel channels.

11. The assembly of claim 10 including a capillary termination feature at the ends of the channels.

12. The assembly of claim 11 wherein channels have a selected depth, and wherein the capillary termination feature is a trough having a greater depth than the channels.

13. A method of manufacturing a ferrule assembly comprising:
providing an elongated ferrule body defining an axis and defining an elongated passage including plurality of channels parallel to the axis, the body defining an access aperture exposing the channels;
providing a fiber optic cable having a plurality of fibers encapsulated in a jacket;
stripping an end portion of the jacket to expose a length of the fibers;
inserting the exposed length of the fibers into the ferrule, each fiber into a channel; and
applying a hermetic sealant to the channels via the aperture.

14. The method of claim 13 wherein the step of inserting includes inserting a portion of the jacket into an enlarged portion of the passage at the rear of the ferrule body.

15. The method of claim 14 including applying elastomeric sealant between the jacket and the body at the enlarged portion.

16. The method of claim 13 wherein applying a hermetic sealant includes applying the sealant from a direction lateral to the axis.

17. The method of claim 13 wherein applying a hermetic sealant includes sealing the access aperture.

18. The method of claim 13 wherein the passage has a forward aperture from which the fibers protrude, and including the step of applying an encapsulant into the forward portion to support the fibers.

19. The method of claim 18 including the step of polishing the ferrule to generate a flush surface including the ferrule body, encapsulant, and fiber ends.

20. The method of claim 13 including filling the opposite ends of the passage with materials that differ from each other and from the hermetic sealant.
